(19) United States
(12) Patent Application Publication
(10) Pub. No.: US 2005/0144416 A1
(43) Pub. Date: Jun. 30, 2005

(54) Data alignment systems and methods

(75) Inventor: Chang-Ming Lin, Cupertino, CA (US)

Correspondence Address: JUNG-HUA KUO;C/O PORTFOLIOIP, P. O. BOX 52050, MINNEAPOLIS, MN, 55402, US

(73) Assignee: Intel Corporation, A DELAWARE CORPORATION, Santa Clara, CA (US)

(21) Appl. No.: 10/749,328

(22) Filed: Dec. 29, 2003

(51) Int. Cl. G06F 12/00

(52) U.S. Cl. 711/201; 711/154

(57) ABSTRACT

Systems and methods are disclosed for aligning data in memory access and other applications. In one embodiment, a group of data is obtained for storage in a memory unit. The memory unit has two banks. If the data is aligned, a first portion of the data is written to the first memory bank and a second portion is written to the second memory bank. If the data is not aligned, the first portion is written to the second memory bank and the second portion is written to the first memory bank. In one embodiment, the data is written to the first and second memory banks in a substantially simultaneous manner.

### BACKGROUND

Advances in networking technology have led to the use of computer networks for a wide variety of applications, such as sending and receiving electronic mail, browsing Internet web pages, exchanging business data, and the like. As the use of computer networks proliferates, the technology upon which these networks are based has become increasingly complex.

Data is typically sent over a network in small packages called “packets,” which are typically routed over a variety of intermediate network nodes before reaching their destination. These intermediate nodes (e.g., routers, switches, and the like) are often complex computer systems in their own right, and may include a variety of specialized hardware and software components.

For example, some network nodes may include one or more network processors for processing packets for use by higher-level applications. Network processors are typically comprised of a variety of components, including one or more processing units, memory units, buses, controllers, and the like.

In some systems, different components may be designed to handle blocks of data of different sizes. For example, a processor may operate on 32-bit blocks of data, while a bus connecting the processor to a memory unit may be able to transport 64-bit blocks. In such a situation, the bus may pack 32-bit blocks of data together to form 64-bit blocks, and then transport these 64-bit blocks to their destination. Once the data reaches its destination, however, it will generally need to be unpacked properly in order to ensure the efficient and correct operation of the system.

### BRIEF DESCRIPTION OF THE DRAWINGS

Reference will be made to the following drawings, in which:

FIG. 1A is a diagram of a network processor.

FIG. 1B illustrates data that is not aligned.

FIGS. 2A and 2B illustrates a system for aligning data in a memory access application.

FIG. 3 is a flowchart of an illustrative process for aligning data.

FIG. 4A is diagram of an illustrative circuit for aligning data in a memory access application.

FIG. 4B is diagram of an alternative embodiment of an illustrative circuit for aligning data in a memory access application.

FIG. 5 is a diagram of an example system in which data alignment circuitry could be deployed.

### DESCRIPTION OF SPECIFIC EMBODIMENTS

Systems and methods are disclosed for aligning data in memory access and other computer processing applications. It should be appreciated that these systems and methods can be implemented in numerous ways, several examples of which are described below. The following description is presented to enable any person skilled in the art to make and use the inventive body of work. The general principles defined herein may be applied to other embodiments and applications. Descriptions of specific embodiments and applications are thus provided only as examples, and various modifications will be readily apparent to those skilled in the art. For example, although several examples are provided in the context of Intel® Internet Exchange network processors, it will be appreciated that the same principles can be readily applied in other contexts as well. Accordingly, the following description is to be accorded the widest scope, encompassing numerous alternatives, modifications, and equivalents. For purposes of clarity, technical material that is known in the art has not been described in detail so as not to unnecessarily obscure the inventive body of work.

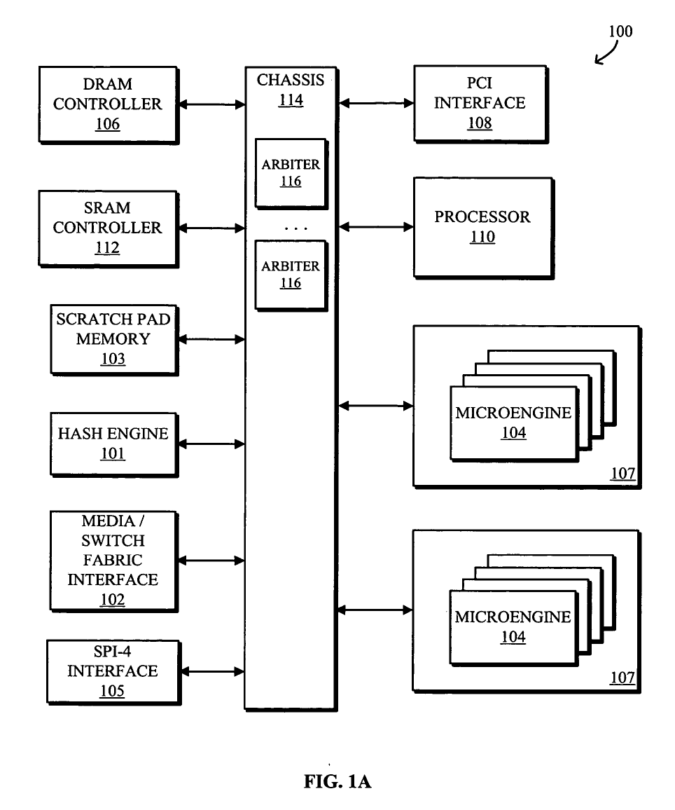

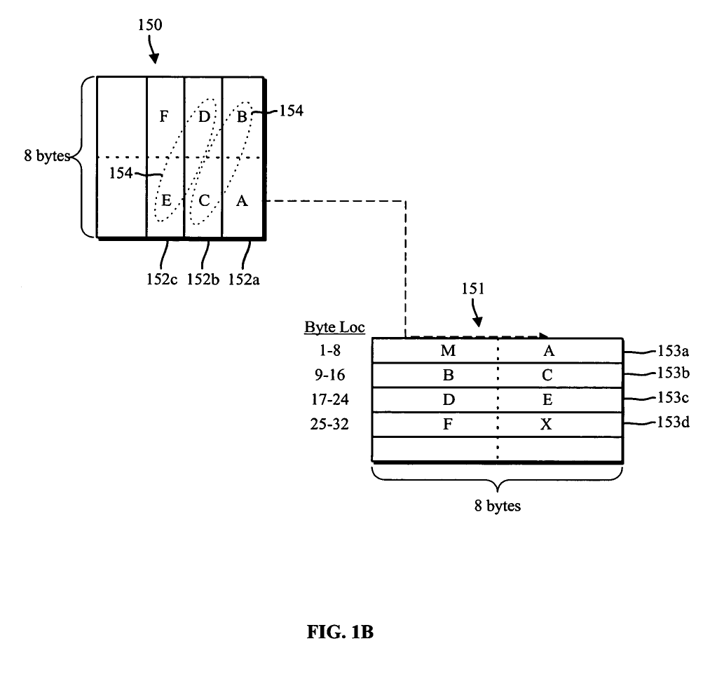

Network processors are typically used to perform packet processing and/or other networking operations. An example of a network processor 100 is shown in FIG. 1A. Network processor 100 has a collection of microengines 104, arranged in clusters 107. Microengines 104 may, for example, comprise multi-threaded, Reduced Instruction Set Computing (RISC) processors tailored for packet processing. As shown in FIG. 1A, network processor 100 may also include a core processor 110 (e.g., an Intel XScale® processor) that may be programmed to perform various “control plane” tasks involved in network operations, such as signaling stacks and communicating with other processors. The core processor 110 may also handle some “data plane” tasks, and may provide additional packet processing threads.

Network processor 100 may also feature a variety of interfaces for carrying packets between network processor 100 and other network components. For example, network processor 100 may include a switch fabric interface 102 (e.g., a Common Switch Interface (CSIX)) for transmitting packets to other processor(s) or circuitry connected to the fabric; an interface 105 (e.g., a System Packet Interface Level 4 (SPI-4) interface) that enables network processor 100 to communicate with physical layer and/or link layer devices; an interface 108 (e.g., a Peripheral Component Interconnect (PCI) bus interface) for communicating, for example, with a host; and/or the like.

Network processor 100 may also include other components shared by the microengines 104 and/or core processor 110, such as one or more static random access memory (SRAM) controllers 1112, dynamic random access memory (DRAM) controllers 106, a hash engine 101, and a low-latency, on-chip scratchpad memory 103 for storing frequently used data. A chassis 114 comprises the set of internal data and command buses that connect the various functional units together. As shown in FIG. 1A, chassis 114 may include one or more arbiters 116 for managing the flow of commands and data to and from the various masters (e.g., processor 110, microengines 104, and PCI unit 108) and targets (e.g., DRAM controller 106, SRAM controller 112, scratchpad memory 103, media switch fabric interface 102, SPI-4 interface 105, and hash engine 101) connected to the bus.

In one embodiment, a microengine 104 or other master might send a request to chassis 114 to write data to a target, such as scratchpad memory 103. An arbiter 116 grants the request and forwards it to the scratchpad memory's controller, where it is decoded. The scratchpad memory's controller then pulls the data from the microengine's transfer registers, and writes it to scratchpad memory 103.

It should be appreciated that FIG. 1A is provided for purposes of illustration, and not limitation, and that the systems and methods described herein can be practiced with devices and architectures that lack some of the components and features shown in FIG. 1A and/or that have other components or features that are not shown.

In some systems such as that shown in FIG. 1A, there may be a disparity between the size of the data blocks handled by microengines 104, processor(s) 110, buses 150, and/or memory 103, 106, 112. For example, microengines 104 might be designed to handle 32-bit blocks (or “words”) of data, while chassis 114 and scratchpad memory 103 might be designed to handle 64-bit blocks. This can lead to problems with data alignment when data is transferred between the various components of the system.

For example, when a 32-bit master (e.g., a microengine) attempts to write data to a target (e.g., scratchpad memory) over a 64-bit bus, the bus arbiter might pack 32-bit data words into 64-bit blocks for transmission to the target. For example, if the master sends a burst of three 32-bit blocks—A, B, and C—the bus arbiter may pack them into two 64-bit blocks. The two 64-bit words might be packed as follows: (B, A), (x, C), where x denotes 32 bits of junk data in the upper 32-bit portion (i.e., the “most significant bits” (MSBs)) of the 64-bit block formed by concatenating x and C.

The alignment problem stems from the fact that the bus arbiter packs the data without regard to the starting address of the target memory location to which the data will be written. If, for example, the starting address is in the middle of a 64-bit memory location, the data will need to be realigned before writing. That is, the 64-bit words received from the bus will not correspond, one-to-one, with the 64-bit memory locations in the target. Instead, half of each 64-bit word received from the bus will correspond to half of one 64-bit target memory location, while the other half of each word received from the bus will correspond to half of another, adjacent 64-bit target memory location.

FIG. 1B illustrates this problem. As shown in FIG. 1B, six 4-byte (i.e., 32-bit) blocks of data (A, B, C, D, E, and F) are packed into three 8-byte (i.e., 64-bit) words 152a-c on bus 150. However, there is not a one-to-one correspondence between 8-byte words 152a-c and the 8-byte memory locations 153a-d in target memory 151. Instead, the lower half of the first 8-byte word 152a (i.e., block A) needs to be written to the upper half of memory location 153a (e.g., in order to avoid overwriting block M), while the upper half of word 152a (i.e., block B) needs to be written to the lower half of memory location 153b, and so forth. Thus, as shown in FIG. 1B, the three 8-byte words 152a-c received from bus 150 contain data that spans four storage locations 153a-d when written to target memory 151. Thus, when writing data from bus 150 to memory 151, the 8-byte words on the bus cannot be transferred directly to 8-byte memory locations with a single 8-byte write operation; instead, the data for a given 8-byte memory location 153 will span multiple words 152 on the bus, as shown in FIG. 1B by dotted lines 154.

One way to ensure that data received from the bus is written correctly to the target is to provide a special buffer at the target. Incoming data can be stored in the buffer, and realigned before being written to the target. A problem with this approach, however, is that it is relatively inefficient, in that it may require incoming data to be read, modified, and rewritten to the buffer before being written to the target—a process that can take multiple clock cycles and result in increased power consumption.

Thus, in one embodiment special circuitry is used to align the data when it is written to the target (as opposed to aligning the data in a separate step before writing it to the target). Data from the system bus is received unchanged in the target's first-in-first-out (FIFO) input queue. The target memory is divided into two banks of, e.g., 32-bit, slots. The starting address of the write operation is examined to determine if the data is aligned. If the data is aligned, a write is performed to both banks simultaneously (e.g., on the same clock cycle), one bank receiving the upper 32-bits of the incoming 64-bit block, and the other memory bank receiving the lower 32-bits. The same address is used to write both 32-bit blocks to their respective memory banks. If the data is not aligned, a write is still performed to both banks simultaneously; however, a different address is used for each bank. One bank uses the starting address, and the other uses the next address after the starting address (i.e., starting address+1). In this way, unaligned data received from the bus is aligned when it is written to the target memory.

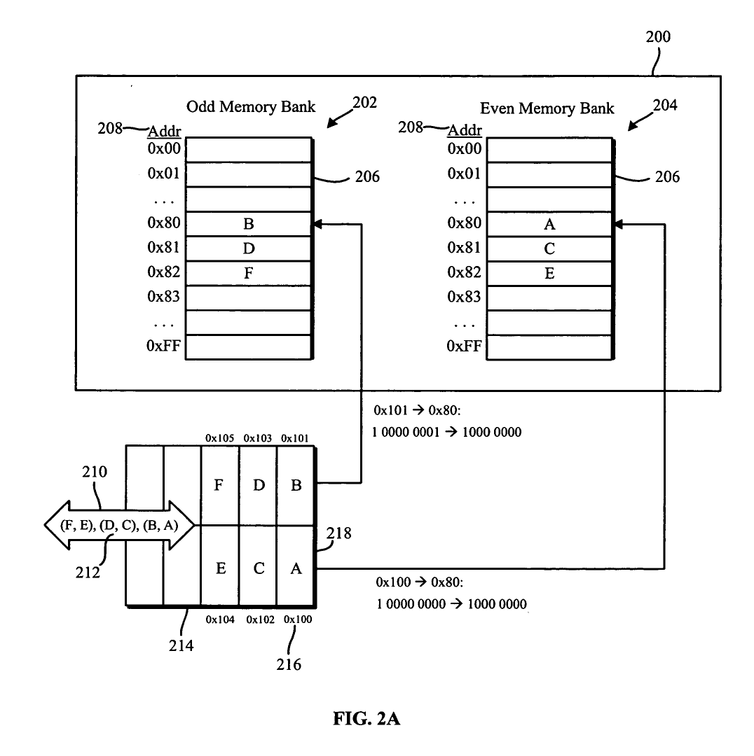

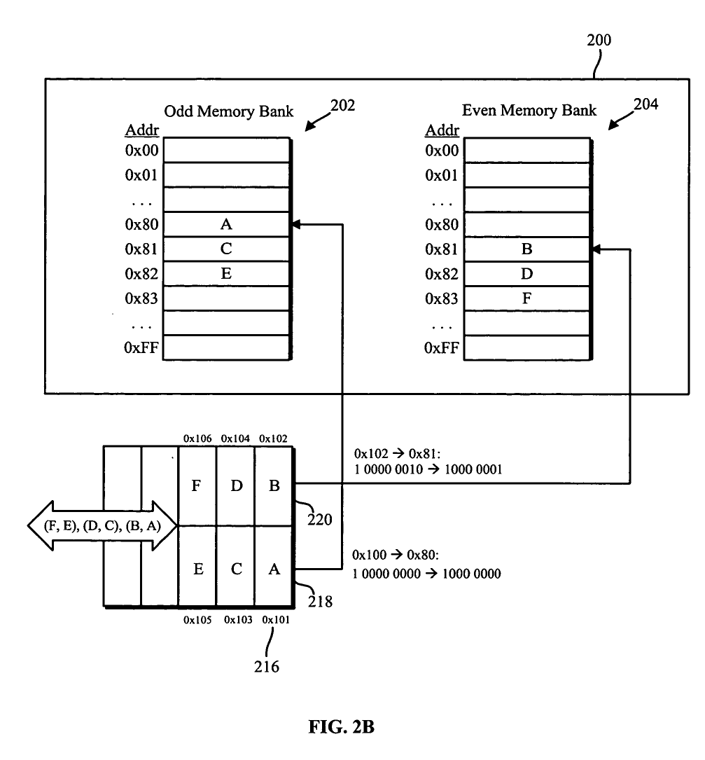

FIGS. 2A and 2B illustrate the operation of a memory unit 200 such as that described above. Memory unit 200 may consist of any suitable memory technology, such as random access memory (RAM), static random-access memory (SRAM), dynamic random access memory (DRAM), and/or the like. For example, memory unit 200 may comprise scratchpad memory 103 in FIG. 1A.

Memory unit 200 is comprised of two parallel banks 202, 204, each comprising a sequence of storage locations 206. The storage locations 206 in each bank 202, 204 are addressable using an n-bit address 208, where n can be any suitable number. In the example shown in FIG. 2A, n is 8 bits and can thus be used to reference 2⁸=256 memory locations. If, for example, each memory location is capable of storing 32 bits of data, then each bank 202, 204 will be capable of holding 256*32=8196 bits (i.e., 1024 bytes).

Referring once again to FIG. 2A, data is received from bus 210 in 64-bit blocks 212, and stored in a first-in-first-out (FIFO) memory 214. Data blocks 212 will often be received in groups, and the data source (and/or the memory unit's write controller) will determine where the blocks should be stored. For example, the data source (or memory unit's write controller) may specify an address 216 at which to start writing the incoming data.

As shown in FIG. 2A, the memory unit's write controller may determine that the lower half of the first block of data (i.e., sub-block A 218) should be written to address 0x100 (where “0x” denotes a hexadecimal (base-16) number). Since this is an even address (i.e., it is divisible by 2), sub-block A 218 is written to the “even” memory bank 204. Similarly, the upper half of the first block of data (i.e., sub-block B) will be written to the “odd” memory bank 202. In one embodiment, both sub-blocks are written to their respective memory banks substantially simultaneously (e.g., in the same clock cycle or other suitably defined time period).

As shown in FIG. 2A, in one embodiment the address to which the sub-blocks are written is obtained by removing the least significant bit of the starting address 216 specified by the write controller. That is, the upper n bits of the n+1-bit starting address are used to address the memory banks. Thus, as shown in FIG. 2A, the starting address specified by the write controller—i.e., 0x100 (or 1 0000 0000 in binary)—is transformed into memory bank address 0x80 (i.e., 1000 0000 in binary) by removing the least significant bit of the starting address. As shown in FIG. 2A, the same address (i.e., 0x80) is used to write each of the separate 32-bit halves of the incoming 64-bit data block to the even and odd memory banks, respectively.

The remainder of the incoming data is written to memory unit 200 in a similar manner. That is, the two 32-bit halves of the next 64-bit data block—i.e., sub-blocks C and D—are written to address 0x81 in the even and odd memory banks, respectively, and sub-blocks E and F are written to address 0x82.

FIG. 2B illustrates the operation of the system shown in FIG. 2A when the incoming data is not aligned. In this example, the data source (or the memory controller) has determined that the incoming data should be stored starting at address 0x101 (216). Since this is an odd address, the lower 32 bits of the first block of data (i.e., sub-block A 218) are written to the “odd” memory bank 202 at address 0x80. The upper 32-bits of the incoming 64-bit block (i.e., sub-block B 220) are written to the “even” memory bank 204; however, these bits are not written to the same address as the lower 32-bits, as was the case in the aligned-data example shown in FIG. 2A. Instead, the upper 32-bits are written to the next address (i.e., 0x81). Both write operations can still, however, be executed in parallel (e.g., they can be executed on the same clock cycle).

In some embodiments, the two bank structure of the memory unit is transparent to the data source and/or the write controller, which can simply treat memory unit 200 as a sequence of 32-bit storage locations. That is, the write controller (and/or the master or other data source) can reference the incoming data—and the storage locations within memory unit 200—in 32-bit blocks using an n+1-bit address. However, as described in more detail below, the two-bank structure of memory unit 200 still enables a full 64-bit word—the same word-size used by the bus—to be written on each clock cycle, thereby enabling faster access to the memory unit. Thus, memory unit 200 is effectively 64 bits wide, in which the 32-bit halves of each 64-bit memory location are separately addressable. Moreover, since the memory's structure is transparent to the data source (e.g., microengine), a 32-bit data source (and/or the software that runs thereon) does not need to be redesigned in order to operate with the 64-bit bus and the two-bank memory unit 200.

It should be appreciated that FIGS. 2A and 2B are provided for purposes of illustration, and not limitation, and that the systems and methods described herein can be practiced with devices and architectures that lack some of the components and features shown in FIGS. 2A and 2B, and/or that have other components or features that are not shown. For example, it will be understood that the size of the various elements (e.g., 64-bit bus, 32-bit data blocks, 32-bit wide memory locations, etc.), and the relative proportions therebetween, have been chosen for the sake of illustration, and that the systems and methods described herein can be readily adapted to systems having components with different dimensions. Moreover, in order to facilitate a description of the flow of data, FIGS. 2A and 2B show the same blocks of data (i.e., A, B, C, etc.) in a variety of locations at the same time (e.g., on bus 210, in FIFO 214, and in memory unit 200). It will be appreciated, however, that in practice this data will typically not be present at each of these locations simultaneously (e.g., when a block of data first arrives on bus 210 for storage in memory unit 200, a copy of that block of data will typically not already be stored in the desired memory location).

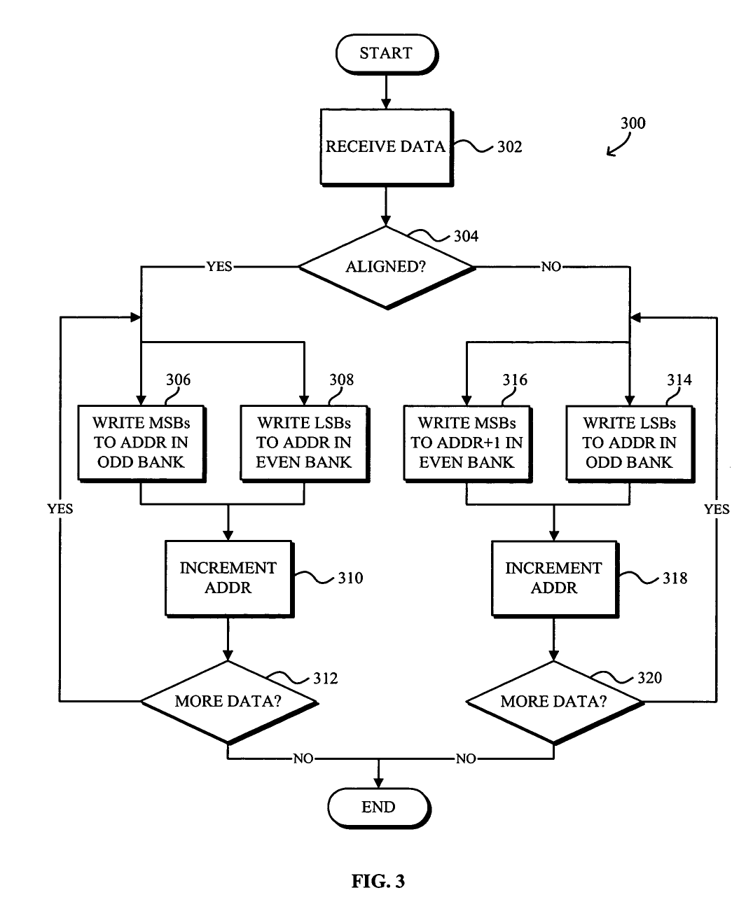

FIG. 3 illustrates a process 300 for writing potentially unaligned data to a memory unit, such as memory unit 200 in FIGS. 2A and 2B. Upon receiving a block of data (e.g., at the memory unit, or at an intermediate location between the source of the data and the memory unit) (block 302), a determination is made as to whether the data is aligned (block 304). For example, the starting address of the location to which the data is to be written can be examined. If the data is aligned (i.e., a “Yes” exit from block 304), then simultaneous write operations are performed to parallel addresses in a two-bank memory, one bank receiving the upper half of the incoming data block (block 306), and the other memory bank receiving the lower half (block 308). The address is then incremented (block 310), and, if there is more data to be written (i.e., a “Yes” exit from block 312), then the process shown in blocks 306-312 repeats itself until all the data has been written (i.e., a “No” exit from block 312).

Referring back to block 304, if the data is not aligned (i.e., a “No” exit from block 304), simultaneous write operations are still performed to both memory banks; however, a different address is used for each bank. One bank uses the starting address specified by, e.g., the data source or the write controller (or an address derived therefrom) (block 314), while the other bank uses the next address after the starting address (i.e., starting address+1) (block 316). In this way, unaligned data is not written to the same parallel addresses in the target memory. As shown in FIG. 3, after the data blocks have been written, the address is incremented (block 318), and, if there is more data to be written (i.e., a “Yes” exit from block 320), the process shown in blocks 314-320 repeats.

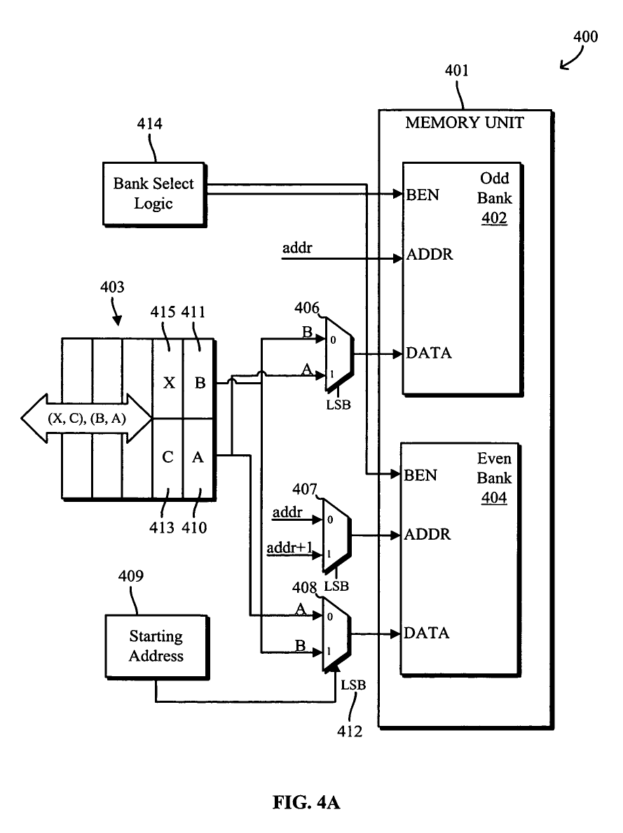

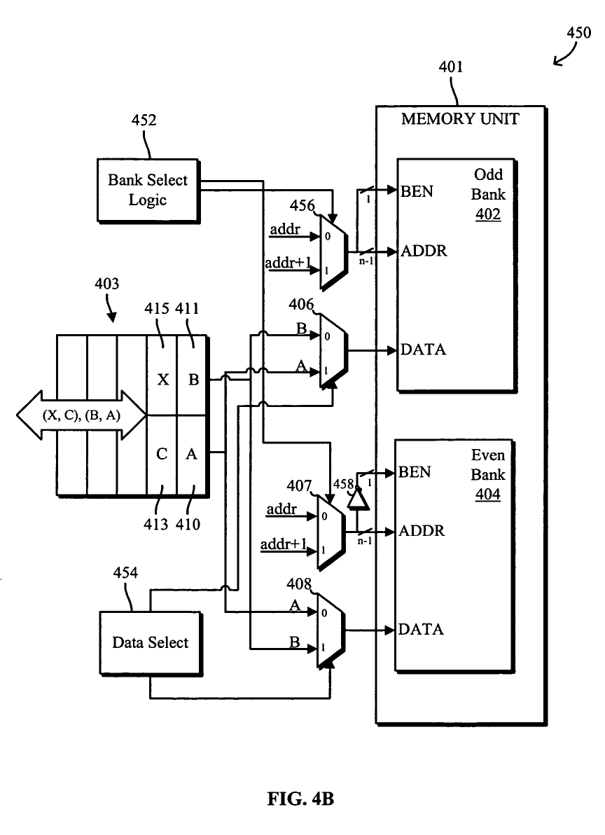

FIG. 4A shows a more detailed example of a system 400 for writing data to a memory unit 401 in the manner described above. As shown in FIG. 4A, in one embodiment incoming data is stored in a FIFO 403, and multiplexors 406, 407, 408 are used to select the memory bank 402, 404, and the address, to which the data is written. In one embodiment the least significant bit (LSB) 412 of the starting address 409 (as specified by, e.g., the data source or the memory unit's write controller) is used to select between the various multiplexor inputs. As shown in FIG. 4A, if the LSB is 1, then input “1” on each multiplexor will be selected; if the LSB is 0, then input “0” will be selected.

Referring to FIG. 4A, if the starting address 409 is odd (i.e., if the data is not aligned), then the LSB will equal 1 and multiplexor 406 will select the lower half of the first block of data contained in FIFO 403 (i.e., sub-block A 410). This data will be written to odd memory bank 402 at the starting address 409 (or at an address derived therefrom, e.g., in the manner described in connection with FIGS. 2A and 2B). Multiplexor 408 will select sub-block B 411 (i.e., the upper half of the first block of data), and pass it to even memory bank 404, where it will be written to the next address location following the starting address (e.g., starting address+1, or an address derived therefrom).

Once the first data block has been written (i.e., block (B, A)), the address input (addr) will be incremented, and on the next cycle sub-block C 413 will be written to the odd memory bank 402 at the new address location (i.e., the initial address+1).

System 400 operates in a similar manner when the incoming data is aligned. When the data is aligned, the starting address 409 will be even, and LSB 412 will equal 0. Thus, the lower half of the incoming data words (i.e., sub-blocks A 410 and C 413) will be written to even bank 404, and the upper half of the incoming words (i.e., sub-block B) will be written to the odd bank 402.

In one embodiment, the data source or the write controller specifies the number of blocks that are to be written to the memory unit. A count is then maintained of the number of blocks that have been written, thereby enabling the system to avoid writing junk data to the memory unit and wasting power on unnecessary write operations. For example, in FIG. 4A three sub-blocks have been sent to memory unit 401 for storage (i.e., sub-blocks A, B, and C). Bank select logic 414 could keep track of the number of sub-blocks that have been written, and could disable each memory bank when no more sub-blocks remain to be written to that memory bank. For instance, in the example described above, bank select logic 414 could disable the even bank 404 once sub-block B 411 was written, thereby preventing junk sub-block X 415 from being written to even bank 404 during the clock cycle in which sub-block C 413 is written to odd bank 402. Similarly, bank select logic could disable odd bank 402 once sub-block C 413 was written to it.

FIG. 4B illustrates an alternative embodiment of the system shown in FIG. 4A. The operation of system 450 shown in FIG. 4B is substantially similar to system 400; however, the structure of system 450 differs in the configuration of bank select logic 452, data select logic 454, multiplexor 456, and inverter 458. Data select logic 454 selects between the inputs of data multiplexors 406 and 408 in the same manner described in connection with FIG. 4A. Bank select logic 452 selects between the two n-bit inputs of address multiplexors 456 and 407. As shown in FIG. 4B, the least significant bit of the n-bit multiplexor output (or an inverted version thereof) is used to drive the bank enable (BEN) inputs of the memory banks. Thus, bank select logic 452 selects between addr and addr+1 such that incoming data blocks are written to the correct memory location, and such that the memory unit is disabled when no further valid data remain to be written. This contrasts to FIG. 4A, in which the inputs to multiplexor 407 comprised n−1 bit addresses, and separate bank select logic 414 was used to enable each bank. It will be appreciated that while FIGS. 4A and 4B show two possible embodiments of a memory system, any of a variety of other embodiments could be used instead. For example, the multiplexors and other circuit elements could be replaced with equivalent logic.

Thus, systems and methods have been described that can be used to improve system performance by facilitating communication between components designed to handle data words of different sizes. For example, in systems with a 64-bit bus and one or more 32-bit masters, the logic and two-bank memory design shown in FIGS. 4A and 4B can be used to execute a 64-bit write in a single cycle—independent of data alignment—thus enabling the system to take advantage of the performance gains made possible by the 64-bit bus.

The systems and methods described above can be used in a variety of computer systems. For example, without limitation, the circuitry shown in FIGS. 4A and 4B can be used to manage data writes in a scratchpad (or other) memory in a network processor such as that shown in FIG. 1A, which may itself form part of a larger system (e.g., a network device).

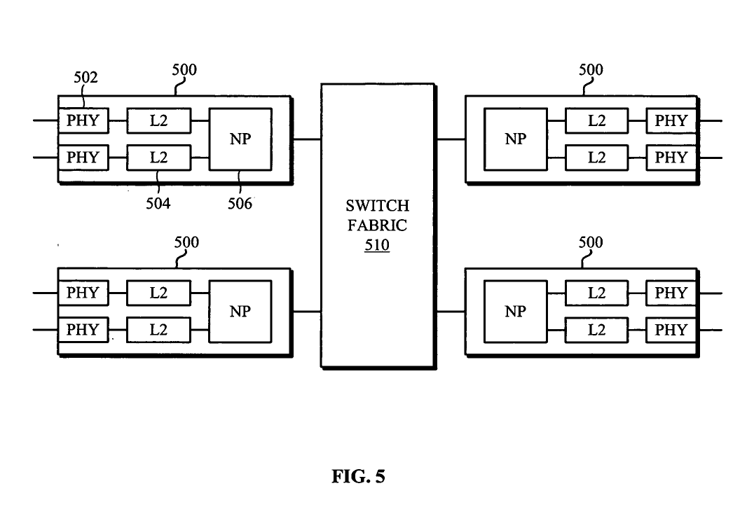

FIG. 5 shows an example of such a larger system. As shown in FIG. 5, the system features a collection of line cards or “blades” 500 interconnected by a switch fabric 510 (e.g., a crossbar or shared memory switch fabric). The switch fabric 510 may, for example, conform to the Common Switch Interface (CSIX) or another fabric technology, such as HyperTransport, Infiniband, PCI-X, Packet-Over-SONET, RapidIO, or Utopia.

Individual line cards 500 may include one or more physical layer devices 502 (e.g., optical, wire, and/or wireless) that handle communication over network connections. The physical layer devices 502 translate the physical signals carried by different network media into the bits (e.g., 1s and 0s) used by digital systems. The line cards 500 may also include framer devices 504 (e.g., Ethernet, Synchronous Optic Network (SONET), and/or High-Level Data Link (HDLC) framers, and/or other “layer 2” devices) that can perform operations on frames such as error detection and/or correction. The line cards 500 may also include one or more network processors 506 (such as network processor 100 in FIG. 1A) to, e.g., perform packet processing operations on packets received via the physical layer devices 502.

While FIGS. 1A and 5 illustrate a network processor and a device incorporating one or more network processors, it will be appreciated that the systems and methods described herein can be implemented in other data processing contexts as well, such as in personal computers, work stations, cellular telephones, personal digital assistants, distributed systems, and/or the like, using a variety of hardware, firmware, and/or software.

Thus, while several embodiments are described and illustrated herein, it will be appreciated that they are merely illustrative. Other embodiments are within the scope of the following claims.

1. A method comprising:
obtaining data to be written to a memory unit;
determining if the data is aligned, and
if the data is aligned, writing a first portion of a first block of the data to a first memory bank of the memory unit, and writing a second portion of the first block of the data to a second memory bank of the memory unit; and
if the data is not aligned, writing the first portion of the first block to the second memory bank and the second portion of the first block to the first memory bank.

2. The method of claim 1, in which:
if the data is aligned, writing the first portion of the first block to the first memory bank at a first address, and writing the second portion of the first block to the second memory bank at the first address; and
if the data is not aligned, writing the first portion of the first block to the second memory bank at a second address, and writing the second portion of the first block to the first memory bank at a third address.

3. The method of claim 1, in which the first portion and the second portion are written to the memory unit substantially simultaneously.

4. The method of claim 3, in which the first portion and the second portion are written to the memory unit on the same clock cycle.

5. A system comprising:
a data source;
a data target, the data target including:
a memory unit, the memory unit including:
a first memory bank; and
a second memory bank;
logic for selecting data to be written to the first memory bank, the logic being operable to select a first portion of a first block of data if the first block of data is aligned, and to select a second portion of the first block of data if the first block of data is not aligned;
logic for selecting data to be written to the second memory bank, the logic being operable to select the first portion of the first block of data if the first block of data is not aligned, and to select the second portion of the first block of data if the first block of data is aligned; and
a bus communicatively connecting the data source and the data target, the bus being operable to transfer the first block of data from the data source to the data target.

6. The system of claim 5, in which the data source comprises a microengine in a network processor.

7. The system of claim 5, in which the data target comprises a scratchpad memory in a network processor.

8. The system of claim 5, further comprising:
logic for selecting an address at which to write data to the first memory bank, the logic being operable to select a first address if the data is aligned, and to select a second address if the data is not aligned.

9. A system comprising:
a memory unit, the memory unit comprising:
a first memory bank; and
a second memory bank;
a first multiplexor, an output of the first multiplexor being communicatively connected to the first memory bank, the first multiplexor being operable to select between a first portion of a first data block and a second portion of the first data block, the selection being based on whether the first data block is aligned, and to pass the selected portion to the first memory bank;
a second multiplexor, an output of the second multiplexor being communicatively connected to the second memory bank, the second multiplexor being operable to select between the first portion of the first data block and the second portion of the first data block, the selection being based on whether the first data block is aligned, and to pass the selected portion to the second memory bank;
a third multiplexor, an output of the third multiplexor being communicatively coupled to an address input of the first memory bank, the third multiplexor being operable to select between a first address and a second address, the selection being based on whether the first data block is aligned, and to pass the selected address to the address input of the first memory bank.

10. The system of claim 9, in which the first portion of the first data block comprises the least significant bits of the first data block, and in which the second portion of the first data block comprises the most significant bits of the first data block.

11. The system of claim 9, further comprising:
bank select logic, the bank select logic being operable to determine whether a first group of data has been written to the first memory bank, and to at least temporarily disable the first memory bank from accepting additional data upon making said determination.

12. The system of claim 9, further comprising:
a FIFO memory operable to store the first data block,
the FIFO memory being communicatively coupled to a bus and operable to accept incoming blocks of data from the bus,
the FIFO memory being further communicatively coupled to the first and second multiplexors.

13. The system of claim 9, further comprising a bus, the bus having a width that is equal to the size of the first data block, the bus being operable to transfer the first data block from a master to the first and second multiplexors.

14. The system of claim 13, in which the master is designed to process blocks of data that are half the width of the first data block.

15. The system of claim 13, in which the first memory bank is half the width of the first data block, and in which the second memory bank is half the width of the first data block.

16. The system of claim 9, in which the first data block is 64-bits long.

17. The system of claim 16, further comprising a 64-bit bus, the 64-bit bus being operable to transfer the first data block from a 32-bit master to the first and second multiplexors.

18. The system of claim 17, in which the master comprises a 32-bit microengine in a network processor.

19. The system of claim 18, in which the memory unit comprises a scratchpad memory in the network processor.

20. A method for writing data to a memory unit, the method comprising:
receiving a sequence of data blocks;
obtaining a memory address at which to start writing the data blocks;
determining whether the starting memory address is even or odd;
if the starting memory address is even;
writing a first portion of a first data block in the sequence to a first memory bank at a location identified by a first address;
writing a second portion of the first data block to a second memory bank at a location identified by the first address;
if the starting memory address is odd;
writing the first portion of the first data block to the second memory bank at a location identified by a second address;
writing the second portion of the first data block to the first memory bank at a location identified by a third address.

21. The method of claim 20, further comprising:
if the starting memory address is even;
writing a first portion of a second data block in the sequence to the first memory bank at a location identified by a fourth address;
writing a second portion of the second data block to the second memory bank at a location identified by the fourth address;
if the starting memory address is odd;
writing the first portion of the second data block to the second memory bank at a location identified by a fifth address;
writing the second portion of the second data block to the first memory bank at a location identified by a sixth address.

22. The method of claim 20, in which the first address is obtained by removing a bit from the starting address.

23. The method of claim 20, further comprising:
updating a count of the amount of data written to the memory unit; and
if the count is less than a predefined value, writing additional data to the memory unit.

24. The method of claim 20, in which the blocks in the sequence comprise 64 bits, and in which the locations in the memory banks are 32 bits wide.

25. A system comprising:
a first line card, the first line card comprising:
one or more physical layer devices;
one or more framing devices; and
one or more network processors, at least one network processor comprising:
a microengine;
a memory unit, the memory unit including:
a first memory bank;
a second memory bank; and
logic for selecting data to be written to the first memory bank, the logic being operable to select a first portion of a first block of data if the first block of data is aligned, and to select a second portion of the first block of data if the first block of data is not aligned;
logic for selecting data to be written to the second memory bank, the logic being operable to select the first portion of the first block of data if the first block of data is not aligned, and to select the second portion of the first block of data if the first block of data is aligned; and
a bus connecting the microengine and the memory unit, the bus being operable to transfer the first block of data from the microengine to the memory unit.

26. The system of claim 25, further comprising:
logic for selecting an address at which to write data to the first memory bank, the logic being operable to select a first address if the data is aligned, and to select a second address if the data is not aligned.

27. The system of claim 25, further comprising:
a second line card; and
a switch fabric operable to communicatively couple the first line card and the second line card.
